(19) United States
(12) Patent Application Publication
(10) Pub. No.: US 2003/0164682 A1
(43) Pub. Date: Sep. 4, 2003

(54) Radiation converter

(76) Inventors: Manfred Fuchs, Nurnberg (DE); Erich Hell, Erlangen (DE); Wolfgang Knupper, Erlangen (DE); Detlef Mattern, Erlangen (DE)

Correspondence Address: SCHIFF HARDIN & WAITE, 6600 SEARS TOWER, 233 S WACKER DR, CHICAGO, IL, 60606-6473, US

(21) Appl. No.: 10/239,547

(22) PCT Filed: Mar. 22, 2001
(86) PCT No.: PCT/DE01/01109

(30) Foreign Application Priority Data
Mar. 23, 2000 (DE) 10014311.3

(51) Int. Cl. H01J 40/18

(52) U.S. Cl. 313/543; 313/103 R

(57) ABSTRACT

The invention relates to a radiation converter having a radiation absorber (2) for generating photons in a manner dependent on the intensity of impinging x-ray radiation, having a photocathode (3) arranged downstream of the radiation absorber (2) in the radiation direction at a distance (a) and serving for generating electrons in a manner dependent on the photons emerging from the radiation absorber (2), having a device for accelerating the electrons emerging from the photocathode onto an electron detector (5) for generating electrical signals in a manner dependent on the impinging electrons, and having an electron multiplier (4) arranged between the photocathode (3) and the electron detector (5), in which case the electrons emerging from the photocathode (3) can be multiplied by the electron multiplier (4).

DE 33 32 648 A1 discloses a radiation converter embodied as an image intensifier. Such image intensifiers have an input window with a radiation absorber for generating light photons in a manner dependent on the radiation intensity of impinging radiation. Arranged downstream of the radiation absorber is a photocathode which generates electrons in a manner dependent on the light photons emerging from the radiation absorber. Said electrons are accelerated onto an electron receiver by an electrode system. In the case of the image intensifier, said electron receiver is embodied as an output screen which generates light photons on account of the impinging electrons.

U.S. Pat. No. 5,369,268 discloses an x-ray detector in which the photocathode is applied on a radiation absorber. The photocathode is arranged at a distance from and opposite an amorphous selenium layer of an output screen.

A further detector device is disclosed in DE 44 29 925 C1. In this case, a shadowmask produced from wires is provided on the radiation input side, a chevron plate being connected downstream of said shadowmask. In order to generate an image signal, a low-impedance anode structure is provided outside the detector on the rear side thereof. EP 0 053 530 discloses a photodetector in which an electron multiplier and a detector anode are connected downstream of a photocathode in the radiation direction.

Since, in the case of medical examination of a patient, in contrast to nondestructive materials testing, the radiation loading must be kept as small as is technically practical, in order to minimize the radiation loading on the patient, efficient utilization of the radiation which penetrates through the patient and impinges on the radiation receiver is the highest requirement. The smaller the radiation intensity impinging on the radiation receiver, however, the smaller, too, are the signals which can be derived from the radiation receiver. The distance between the signal levels and the noise signals likewise becomes smaller, which is associated with a poorer diagnosis capability of the image representations that can be generated on the basis of these signals. It is thus necessary to make a compromise between a small radiation loading on the patient and the radiation dose required for a good diagnosis capability of radiographic images of the patient that can be generated.

A photographic film is, for example, nothing more than a chemical amplifier which amplifies the ionization processes of the radiation in the microscopic region by many orders of magnitude and makes them visible in the macroscopic region.

Storage phosphor panels store the radiation shadow image of an object in latent fashion. By scanning the storage phosphor panel using a light beam, light photons are generated on account of the latent image and are converted by a read-out with a photomultiplier into electrons which can be amplified virtually in noise-free fashion by up to a factor of 10⁶ and be converted into electrical signals. These electrical signals are then available for the image representation.

In x-ray image intensifiers, the geometrical size reduction which results on account of a large input window and a smaller output window is used for intensifying the luminance, assistance for this being provided by the energy absorption of the electrons from the input fluorescent screen to the output fluorescent screen through an intervening acceleration field.

In the case of so-called flat panel image detectors, a layer which converts radiation into light and has CsI, for example, is brought into direct contact with a photodiode matrix made of amorphous silicon, so that the light photons generated by the layer on account of impinging radiation can be converted by means of the photodiode matrix into electrical signals which are then available for the image representation. Since the light photons are not amplified by means of electrons, only relatively small signals can be derived from the photodiode matrix, which signals can only be amplified in a device connected downstream, e.g. an amplifier. Since the quantities of charge of these relatively small electrical signals must then also additionally be conducted, by means of complicated timing methods, from the in part large-area flat panel image detectors via relatively long lines as far as the amplifiers, the mean noise, measured in electrons, is almost twice as great as the signal generated by individual x-ray quanta. Particularly for fluoroscopy, in which only small x-ray doses are applied, the signals which can be derived from the flat panel image detector are particularly small and near the region of the noise and thus require complicated artifact corrections. In fluoroscopy, by way of example, the signals of every second beam scanning are used for correction purposes, so that nothing like the customary image refresh rates can be achieved. Moreover, the dynamic range of the signals which can be derived from the flat panel image detector is greatly restricted.

In today's flat panel image detectors, predominantly a-Si:H read-out panels are used as electron detectors. Operation of such flat panel image detectors in different operating modes, such as fluoroscopy and radiography, which differ by dose factors of 100-1000, requires a high computation complexity. In operated with a high dose, to the fluoroscopy operating mode, operated with a low dose, residual images in the a-Si:H the transition from the radiography operating mode, read-out panel must be removed computationally by subtraction.

It is an object of the invention to specify a radiation converter which can be used as universally as possible. It is a further aim to improve the dynamic range of the radiation converter.

This object is achieved by means of the features of patent claim 1. Expedient refinements of the invention emerge from the features of patent claims 2-13.

In the case of the radiation converter according to the invention, a distance is provided between the radiation absorber and the photocathode. As a result, the effect of UV photons which adversely influences the measurement can be reduced. The dynamic range of the radiation converter proposed is improved. A further advantage is that the photocathode no longer need be embodied in transparent fashion on account of the arrangement proposed here. It is thereby possible to attain a cost saving.

The distance is advantageously between 10 and 100 μm. A distance of about 50 μm has proved to be particularly advantageous. The photocathode may expediently be formed in opaque fashion. UV photons from the avalanche region cannot directly pass to the photocathode.

According to a further refinement feature, the photocathode is produced from a metallic material which preferably contains gold, cesium, copper or antimony. It is expedient, furthermore, that the photocathode is formed as a layer on the electron multiplier, in which case the electron multiplier may in turn be formed as a layer on the electron detector. According to a particularly advantageous embodiment, the electron produced from polyimide. The diameter of the holes is about 25 μm. multiplier has a perforated plastic film preferably

It is advantageous if the radiation absorber, the electrode system, the electron multiplier and the electron detector are assigned a common, gastight housing, thereby producing a compact construction of the radiation converter. A gas which absorbs UV photons is preferably accommodated in the housing. The gas may have at least one of the following constituents: argon, krypton, xenon, helium, neon, CO₂, N₂, hydrocarbon, dimethyl ether, methanol/ethanol vapor.

The radiation absorber advantageously converts radiation into light photons particularly when it has an acicular structure and comprises CsI:Na.

In a particularly advantageous manner, the electron detector is embodied as a 2D thin-film panel and comprises a-Se, a-Si:H or poly-Si. Such an electron detector has a simple construction and is cost-effective.

Further advantages and details of the invention emerge from the following description of an exemplary embodiment with reference to the drawings, wherein:

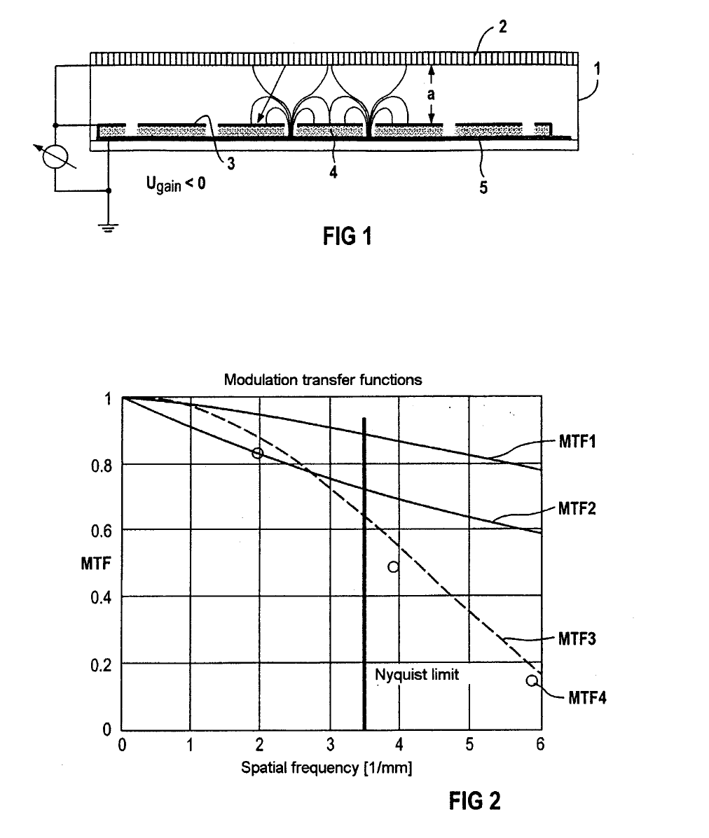

FIG. 1 shows a diagrammatic cross-sectional view of a radiation converter, and

FIG. 2 shows the modulation transfer function as a function of the spatial frequency.

In the case of the radiation converter shown in FIG. 1, the reference symbol 1 designates a housing. The housing has a radiation absorber 2, which converts radiation into light photons. The radiation absorber 2 is either embodied as a separate part or arranged outside the housing 1 in the region of a first end. It comprises a scintillator material, preferably CsI:Na in direction of a photocathode 3. a needle structure, the needles being directed in the

The photocathode 3 is arranged at a distance a of about 50 μm away from the radiation absorber 2. It is embodied as a layer, preferably produced from copper, on a perforated polyimide film 4. The polyimide film 4 acts as an electron multiplier. It is applied to an electron detector 5. The electron detector 5 preferably has a pixel structure and converts the impinging electrons into electrical signals which can be derived by means of suitable known measures, for example an electrical line, and which enable an image representation on a display device. For this purpose, the electron detector 5 is preferably embodied as a 2D thin-film panel and may preferably comprise a-Se, a-Si:H or poly-Si. A gas, in particular quenching gas, for example a mixture of argon and hydrocarbon, is accommodated within the housing 1, in particular between the radiation absorber 2 and the photocathode 3.

The device functions as follows:

X-rays are absorbed by the radiation absorber 2 and converted into photons in the process. The photons liberate photoelectrons from the photocathode 3. The photoelectrons pass into the region of the perforated polyimide film 4. A potential is applied between the photocathode 3 and the electron detector 5. What is achieved by the applied electrical potential is that all the photoelectrons are drawn from the surface of the photocathode 3 into the nearest holes. Charge carrier multiplication takes place in the greatly increasing electric field as a result of impact ionization. The charge carrier multiplication or amplification can be set by the magnitude of the applied potential. The signal/noise ratio can thus be improved. The photoelectrons are accelerated by the applied potential onto the electron detector. The charges accumulated there are read out with a predetermined timing sequence.

In order to reduce UV photons, the radiation absorber 2 may be provided with a UV-photon-absorbing conductive layer. The quenching gas absorbs the UV photons generated during the [lacuna] by impact ionization, in order that said photons do not pass to the photocathode 3, where they could release photoelectrons in an undesired manner.

In FIG. 2, the modulation transfer function is plotted against the spatial frequency. The curves MTF 1 and MTF 2 show the modulation transfer function in the case of a distance between the photocathode 3 and the radiation absorber 2 of 50 μm. The curve MTF 2 shows the point image function of an isotropic point source, and the curve MTF 1 shows the aforementioned point image function for a Lambert source.

The curve MTF 3 shows the modulation transfer function, here the radiation absorber 2 being in direct contact with the electron detector 5. The curve MTF 3 thus represents the characteristic of conventional flat detectors. The values MTF 4 specify the modulation transfer function for a Lambert source, the radiation absorber 2 being arranged at a distance of 50 μm from the electron detector 5. It is shown that the spaced-apart arrangement does not entail a significant change to the modulation transfer function.

1. A radiation converter having a radiation absorber (2) for generating photons in a manner dependent on the intensity of impinging x-ray radiation,
having a photocathode (3) arranged downstream of the radiation absorber (2) in the radiation direction at a distance (a) and serving for generating electrons in a manner dependent on the photons emerging from the radiation absorber (2),
having a device for accelerating the electrons emerging from the photocathode (3) onto an electron detector (5) for generating electrical signals in a manner dependent on the impinging electrons, and
having an electron multiplier (4) arranged between the photocathode (3) and the electron detector (5), in which case the electrons emerging from the photocathode (3) can be multiplied by the electron multiplier (4).

2. The radiation converter as claimed in claim 1, in which case the distance (a) is between 10 and 100 μm.

3. The radiation converter as claimed in one of the preceding claims, in which case the photocathode (3) is opaque.

4. The radiation converter as claimed in one of the preceding claims, in which case the photocathode (3) is produced from a metallic material which preferably contains gold, cesium, copper or antimony.

5. The radiation converter as claimed in one of the preceding claims, in which case the photocathode (3) is formed as a layer on the electron multiplier (4).

6. The radiation converter as claimed in one of the preceding claims, in which case the electron multiplier (4) is formed as a layer on the electron detector (5).

7. The radiation converter as claimed in one of the preceding claims, in which case the electron multiplier (4) has a perforated plastic film preferably produced from polyimide.

8. The radiation converter as claimed in one of the preceding claims, in which case the radiation absorber (2), the electron multiplier (4) and the electron detector (5) are accommodated in a common gastight housing (1).

9. The radiation converter as claimed in one of the preceding claims, in which case a gas absorbing UV photons is accommodated in the housing (1).

10. The radiation converter as claimed in one of the preceding claims, in which the gas has at least one of the following constituents: argon, krypton, xenon, helium, neon, CO₂, N₂, hydrocarbon, dimethyl ether, methanol/ethanol vapor.

11. The radiation converter as claimed in one of the preceding claims, in which the radiation absorber (2) is produced from a scintillator material which preferably has an acicular structure comprising CsI:Na.

12. The radiation converter as claimed in one of the preceding claims, in which the electron detector (5) is embodied as a 2D thin-film panel.

13. The radiation converter as claimed in one of the preceding claims, in which the 2D thin-film panel is formed from a-Se, a-Si:H or poly-Si.
